(19) United States
(12) Patent Application Publication
(10) Pub. No.: US 2021/0208568 A1
(43) Pub. Date: Jul. 8, 2021

(54) System, Apparatus, Manufacturing Machine, Measuring Device and Method for Manufacturing a Product

(71) Applicant: Siemens Aktiengesellschaft, Munchen (DE)

(72) Inventors: Stefan Krause, Leipzig (DE); Christian Lipp, Waldkirchen (DE); Alexander Nowitschkow, München (DE); Peter Robl, Röhrnbach (DE)

(73) Assignee: Siemens Aktiengesellschaft, München (DE)

(21) Appl. No.: 17/059,713

(22) PCT Filed: May 2, 2019
(86) PCT No.: PCT/EP2019/061219

§ 371 Date: Nov. 30, 2020

(30) Foreign Application Priority Data
May 29, 2018 (EP) 18174890.6

(51) Int. Cl. G05B 19/4099; B33Y 50/02

(52) U.S. Cl. CPC G05B 19/4099; B33Y 50/02; G05B 2219/37205; G05B 2219/31444; G05B 2219/37617; G05B 2219/35134; G05B 2219/50063

(57) ABSTRACT

Various embodiments include a manufacturing system comprising: a communication module for receiving a three-dimensional model and control commands including manufacturing instructions for the manufacturing machine with respective reference values, tolerance values, and/or intervention tolerance values; a manufacturing module, wherein the model, the instructions, and the commands are used to manufacture an object; a calculating module using the three-dimensional model and the manufacturing instructions to calculate the control commands; and a measuring device having a communication module for receiving the three-dimensional model, a capture module using sensors to measure the manufactured object, captured for the reference values and/or the tolerance values and/or intervention tolerance values, and a checking module, wherein a divergence of the measured values from the applicable manufacturing reference values and an exceeding of the associated manufacturing tolerance values and/or the associated intervention tolerance values result in a control signal.

### CROSS-REFERENCE TO RELATED APPLICATIONS

This application is a U.S. National Stage Application of International Application No. PCT/EP2019/061219 filed May 2, 2019, which designates the United States of America, and claims priority to EP Application No. 18174890.6 filed May 29, 2018, the contents of which are hereby incorporated by reference in their entirety.

### TECHNICAL FIELD

The present disclosure relates to manufacturing processes. Various embodiments of the teachings herein may include systems, apparatuses, manufacturing machines, measuring devices, and/or methods for manufacturing a product.

### BACKGROUND

It is customary in industrial settings to use an analog 2D drawing as a product definition document during manufacture.

### SUMMARY

The teachings of the present disclosure may be used to improve a manufacturing process in respect of the manufacture of a product. For example, some embodiments of the teachings herein may include a manufacturing system comprising: a manufacturing machine having a first communication module for receiving a three-dimensional model and/or control commands, wherein the three-dimensional model comprises manufacturing instructions for the manufacturing machine; the respective manufacturing instructions have manufacturing reference values and/or manufacturing tolerance values and/or intervention tolerance values assigned to them; a manufacturing module, wherein the three-dimensional model, the manufacturing instructions and the control commands are used to configure the manufacturing machine such that an object corresponding to the three-dimensional model is manufactured; a calculating module, wherein the calculating module uses the three-dimensional model and the manufacturing instructions to calculate the control commands; a measuring device having a second communication module for receiving the three-dimensional model; a capture module, wherein the capture module uses sensors to capture measured values for the manufactured object, the measured values are captured in each case for the manufacturing reference values and/or the manufacturing tolerance values and/or intervention tolerance values; a checking module, wherein a divergence of the measured values from the applicable manufacturing reference values and an exceeding of the associated manufacturing tolerance values and/or the associated intervention tolerance values result in a control signal being provided.

In some embodiments, the control signal is used to control rejection of the object to be manufactured in the event of one of the applicable manufacturing tolerance values being exceeded, or the control signal is used to control refinishing of the object to be manufactured in the event of one of the applicable manufacturing tolerance values being exceeded or the control signal is used to control production of a replacement for the object to be manufactured in the event of one of the applicable manufacturing tolerance values being exceeded.

In some embodiments, the control signal is used to control recalibration of the measuring device and/or of the manufacturing machine in the event of one of the applicable manufacturing tolerance values and/or of the applicable intervention tolerance values being exceeded, and/or the control signal is used to control fresh capture and checking of the applicable measured values in the event of one of the applicable manufacturing tolerance values and/or of the applicable intervention tolerance values being exceeded, and/or the control signal is used to control exchange of a tool in the event of one of the applicable manufacturing tolerance values and/or of the applicable intervention tolerance values being exceeded.

In some embodiments, the manufacturing instructions are assigned to stipulated surfaces of the three-dimensional model.

In some embodiments, the control commands and/or the manufacturing instructions are used to select one or more tools, in particular different tools are selected for the stipulated surfaces of the three-dimensional model.

In some embodiments, the control commands and/or the manufacturing instructions are used by the manufacturing machine to select one or more tools while taking into consideration a location of the manufacturing machine, in particular different tools are selected for the stipulated surfaces of the three-dimensional model.

In some embodiments, an appropriate tool is selected on the basis of the associated manufacturing reference values and/or the manufacturing tolerance values and/or the intervention tolerance values.

In some embodiments, the three-dimensional model is transmitted from a providing apparatus to the manufacturing system and/or the manufacturing machine and/or the measuring device.

In some embodiments, the manufacturing instructions comprise necessary prerequisites for subsequent manufacturing instructions.

In some embodiments, the manufacturing instructions and the three-dimensional model stipulate structures to be manufactured for the object to be manufactured.

In some embodiments, the selection of an appropriate tool is optimized on the basis of the associated manufacturing reference values and/or the manufacturing tolerance values and/or the intervention tolerance values.

As another example, some embodiments include an apparatus having: a providing module for providing a three-dimensional model, wherein the three-dimensional model comprises manufacturing instructions for a manufacturing machine, the three-dimensional model and the manufacturing instructions are used by the manufacturing machine to calculate control commands; the three-dimensional model, the manufacturing instructions and the control commands are used to configure the manufacturing machine such that an object corresponding to the three-dimensional model is manufactured.

In some embodiments, the respective manufacturing instructions have manufacturing reference values and/or manufacturing tolerance values and/or intervention tolerance values assigned to them, in particular the intervention tolerance values permit a smaller divergence from manufacturing reference values than the manufacturing tolerance values.

In some embodiments, measured values for the object to be manufactured are captured by a measuring device, the manufacturing reference values and/or the manufacturing tolerance values and/or intervention tolerance values are used to configure the measuring device such that a divergence of measured values from the applicable manufacturing tolerance values and an exceeding of the associated manufacturing tolerance values and/or the associated intervention tolerance values result in a control signal being provided.

In some embodiments, the manufacturing instructions take into consideration necessary prerequisites for subsequent manufacturing instructions.

As another example, some embodiments include a manufacturing machine comprising a first communication module for receiving a three-dimensional model and/or control commands, wherein the three-dimensional model comprises manufacturing instructions for the manufacturing machine; a manufacturing module, wherein the three-dimensional model, the manufacturing instructions and the control commands are used to configure the manufacturing machine such that an object corresponding to the three-dimensional model is manufactured.

As another example, some embodiments include a measuring device comprising: a second communication module for receiving a three-dimensional model, wherein the three-dimensional model comprises manufacturing instructions, the respective manufacturing instructions have manufacturing reference values and/or manufacturing tolerance values and/or intervention tolerance values assigned to them; a capture module, wherein the capture module uses sensors to capture measured values for a manufactured object, the object is manufactured on the basis of the three-dimensional model and the manufacturing instructions, the measured values are captured in each case for the manufacturing reference values and/or the manufacturing tolerance values and/or intervention tolerance values; a checking module, wherein a divergence of the measured values from the applicable manufacturing reference values and an exceeding of the associated manufacturing tolerance values and/or the associated intervention tolerance values result in a control signal being provided.

As another example, some embodiments include a method for the computer-aided manufacture of an object by means of a manufacturing machine, having the following method steps: receiving a three-dimensional model and/or control commands, wherein the three-dimensional model comprises manufacturing instructions for the manufacturing machine; and manufacturing an object corresponding to the three-dimensional model, wherein the three-dimensional model, the manufacturing instructions and the control commands are used to configure the manufacturing machine such that the object is manufactured.

As another example, some embodiments include a method for the computer-aided checking of an object manufactured by means of a manufacturing machine and/or of a manufacturing machine, having the following method steps: receiving a three-dimensional model, wherein the three-dimensional model comprises manufacturing instructions, the respective manufacturing instructions have manufacturing reference values and/or manufacturing tolerance values and/or intervention tolerance values assigned to them; capturing measured values, wherein the measured values are captured for the manufactured object by means of sensors, the object is manufactured on the basis of the three-dimensional model and the manufacturing instructions, the measured values are captured in each case for the manufacturing reference values and/or the manufacturing tolerance values and/or the intervention tolerance values; checking the measured values, wherein the measured values are compared against the reference values, a divergence of the measured values from the applicable manufacturing reference values and an exceeding of the associated manufacturing tolerance values and/or the associated intervention tolerance values result in a control signal being provided.

As another example, some embodiments include a method for the computer-aided manufacture of an object by means of a manufacturing machine, having the following method steps: receiving a three-dimensional model and/or control commands, wherein the three-dimensional model comprises manufacturing instructions, the respective manufacturing instructions have manufacturing reference values and/or manufacturing tolerance values and/or intervention tolerance values assigned to them; manufacturing an object corresponding to the three-dimensional model, wherein the three-dimensional model, the manufacturing instructions and the control commands are used to configure the manufacturing machine such that the object is manufactured; capturing measured values, wherein the measured values are captured for the manufactured object by means of sensors, the measured values are captured in each case for the manufacturing reference values and/or the manufacturing tolerance values and/or the intervention tolerance values; checking the measured values, wherein a divergence of the measured values from the applicable manufacturing reference values and an exceeding of the associated manufacturing tolerance values and/or the associated intervention tolerance values result in a control signal being provided.

As another example, some embodiments include a computer program product having program commands for performing the methods as described herein.

As another example, some embodiments include a computer program product having program commands for a creating device that is configured by means of the program commands in order to create the apparatus as described herein and/or the manufacturing machine as described herein and/or the measuring device as described herein and/or the manufacturing system as described herein.

As another example, some embodiments include a providing apparatus for the computer program product as described herein, wherein the providing apparatus stores and/or provides the computer program product.

### BRIEF DESCRIPTION OF THE DRAWINGS

The properties, features, and advantages of the teachings of the present disclosure described above and the way in which they are achieved will become clearer and more plainly comprehensible in conjunction with the description of the exemplary embodiments that follows, said exemplary embodiments being explained in more detail in conjunction with the figures, in which, in a schematic depiction:

FIG. 1 shows a first exemplary embodiment incorporating teachings of the present disclosure;

FIG. 2 shows a second exemplary embodiment incorporating teachings of the present disclosure;

FIG. 3 shows a third exemplary embodiment incorporating teachings of the present disclosure;

FIG. 4 shows a fourth exemplary embodiment incorporating teachings of the present disclosure;

FIG. 5 shows a fifth exemplary embodiment incorporating teachings of the present disclosure;

FIG. 6 shows a sixth exemplary embodiment incorporating teachings of the present disclosure;

FIG. 7 shows a seventh exemplary embodiment incorporating teachings of the present disclosure;

FIG. 8 shows a further exemplary embodiment incorporating teachings of the present disclosure;

FIG. 9 shows a further exemplary embodiment incorporating teachings of the present disclosure; and

FIG. 10 shows a further exemplary embodiment incorporating teachings of the present disclosure.

In the figures, functionally identical elements are provided with the same reference signs, unless indicated otherwise.

### DETAILED DESCRIPTION

Various teachings of the present disclosure include manufacturing systems comprising: a manufacturing machine having a first communication module for receiving a three-dimensional model and/or control commands, wherein the three-dimensional model comprises manufacturing instructions for the manufacturing machine; the respective manufacturing instructions have manufacturing reference values and/or manufacturing tolerance values and/or intervention tolerance values assigned to them a manufacturing module, wherein the three-dimensional model, the manufacturing instructions and the control commands are used to configure the manufacturing machine such that an object corresponding to the three-dimensional model is manufactured; a calculating module, wherein the calculating module uses the three-dimensional model and the manufacturing instructions to calculate the control commands; a measuring device having a second communication module for receiving the three-dimensional model; a capture module, wherein the capture module uses sensors to capture measured values for the manufactured object, the measured values are captured in each case for the manufacturing reference values and/or the manufacturing tolerance values; a checking module, wherein in particular the measured values are used to check whether the manufactured object complies with the reference values and/or the tolerance values, in particular the measured values are compared against the reference values and/or the tolerance values, in particular a divergence of the measured values from the applicable manufacturing reference values and an exceeding of the associated manufacturing tolerance values and/or the associated intervention tolerance values result in a control signal being provided.

Unless indicated otherwise in the description that follows, the terms “perform”, “calculate”, “computer-aided”, “compute”, “establish”, “generate”, “configure”, “reconstruct” and the like refer to actions and/or processes and/or processing steps that change and/or generate data and/or that convert data into other data, the data being able to be presented or available in particular as physical variables, for example as electrical impulses. In particular, the expression “computer” should be interpreted as broadly as possible to cover all electronic devices having data processing properties. Computers can therefore include: personal computers, servers, programmable logic controllers (PLCs), handheld computer systems, pocket PC devices, mobile radios, and other communication devices that can process data on a computer-aided basis, processors and other electronic devices for data processing, for example.

“Computer-aided” can be understood within the context of the disclosure to mean for example an implementation of the method in which a processor carries out at least one method step of the method.

A “processor” can be understood within the context of the disclosure to mean for example a machine or an electronic circuit. A processor can include a main processor (central processing unit, CPU), a microprocessor or a microcontroller, for example an application-specific integrated circuit or a digital signal processor, possibly in combination with a memory unit for storing program commands, etc. A processor can, by way of example, also include an IC (integrated circuit), in particular an FPGA (field programmable gate array) or an ASIC (application-specific integrated circuit), or e.g. a multichip module, e.g. a 2.5D or 3D multichip module, in which in particular multiple “dies” are connected to one another directly or via an interposer, or a DSP (digital signal processor) or a graphics processor GPU (graphic processing unit). A processor can also be understood to include a virtualized processor, a virtual machine, or a soft CPU. By way of example, it can also be a programmable processor equipped with configuration steps for carrying out said method according to the invention or configured using configuration steps such that the programmable processor implements the features of the method, of the component, of the modules, or of other aspects and/or subaspects of the present disclosure.

A “memory unit” or “memory module” and the like can be understood within the context of the disclosure to mean for example a volatile memory in the form of main memory (random access memory, RAM) or a permanent memory such as a hard disk or a data carrier or e.g. a removable memory module.

A “module” can be understood within the context of the disclosure to mean for example a processor and/or a memory unit for storing program commands. By way of example, the processor is specifically configured to execute the program commands such that the processor performs functions in order to implement or perform the method according to the invention or a step of the method according to the invention.

“Comprise”, in particular in relation to data and/or information, can be understood within the context of the disclosure to mean for example (computer-aided) storage of applicable information or an applicable datum in a data structure (that is e.g. in turn stored in a memory unit).

“Assign”, in particular in relation to data and/or information, can be understood within the context of the disclosure to mean for example computer-aided assignment of data and/or information. By way of example, a second datum is assigned to a first datum in this regard by means of a memory address or a unique identifier (UID), e.g. by storing the first datum together with the memory address or the unique identifier of the second datum together in a data record.

“Provide”, in particular in relation to data and/or information, can be understood within the context of the disclosure to mean for example computer-aided provision. Provision is effected for example via an interface (e.g. a database interface, a network interface, an interface to a memory unit). Applicable data and/or information can be transmitted and/or sent and/or retrieved and/or received via this interface in the course of the provision, for example.

A “manufactured object”, “object to be manufactured” and the like can be understood within the context of the disclosure to mean for example a product or an object or a workpiece whose machining requires at least one tool (e.g. a milling cutter or a drill) and/or whose manufacture involves one or more surface or material machining operations being effected by a tool. In some embodiments, the machining may require one or more manufacturing machines selected in particular on the basis of the three-dimensional model and/or the manufacturing instructions so that the object to be manufactured is produced by the machines.

A “three-dimensional model” and the like can be understood within the context of the disclosure to mean for example a to-scale (digital) three-dimensional model (e.g. in the form of a CAD model) of the object to be manufactured. The three-dimensional model is in particular a digital or virtual model of the object to be manufactured that additionally comprises the necessary information (manufacturing instructions and/or tolerance specifications) to allow for example one or more manufacturing machines to be determined or selected, to which the applicable data of the three-dimensional model can then be sent (or transmitted), so that the applicable manufacturing machines can produce the object to be manufactured. The three-dimensional model may comprise the manufacturing instructions and/or tolerance specifications that are assigned to surfaces of the three-dimensional model. These surfaces can be used to define structures to be manufactured (e.g. drill holes, cutouts, protuberances) and the size and position thereof on the object to be manufactured, for example. In some embodiments, the three-dimensional model and the manufacturing instructions stipulate or map out (e.g. by means of the manufacturing reference values) structures to be manufactured (e.g. geometric structures to be manufactured) during the manufacture of the object to be manufactured.

In some embodiments, the manufacturing instructions can comprise prerequisites for performance of the manufacturing instructions by a manufacturing machine. These prerequisites can stipulate a sequence of machining steps for the object to be manufactured or else define material protrusions (or offsets) that are e.g. necessary for the next processing step. In some embodiments, a manufacturing machine rates or takes into consideration these prerequisites, for example, and leaves enough material over during the performance of a first manufacturing instruction for e.g. one or more subsequent manufacturing instructions to still be able to be performed to manufacture the object.

In some embodiments, the manufacturing instructions can be assigned to stipulated positions of the three-dimensional model. The manufacturing instructions comprise for example instructions and/or specifications and/or stipulations so that structures to be manufactured (e.g. geometric structures such as protuberances, surface machining operations such as sanding or coating) can be manufactured at the stipulated positions on the object to be manufactured. In some embodiments, the respective positions of the structures to be manufactured on the three-dimensional model correspond to the positions of the structures that are created on the object to be manufactured. In other words, the structures to be manufactured are therefore spatially or geometrically mapped out by the stipulated positions on the three-dimensional model itself by means of the manufacturing instructions, wherein the stipulated positions on the three-dimensional model correspond to the real positions of the structures to be manufactured on the object to be manufactured. In other words, the three-dimensional model is for example a data record or a data structure that e.g. comprises geometric data and manufacturing data or manufacturing instructions for manufacturing an object (e.g. the object to be manufactured). The three-dimensional model may comprise a three-dimensional/virtual model of the object to be manufactured that is used to control the manufacturing process for producing the object to be manufactured. Tolerance specifications or tolerance values are understood to mean for example the manufacturing tolerance values and/or the intervention tolerance values. Reference specifications or reference values are understood to mean for example the manufacturing reference values.

“Manufacturing reference values” and the like can be understood within the context of the disclosure to mean for example exact dimensions of the object to be manufactured and/or measurable properties of the object to be manufactured and/or measurable sizes (e.g. of structures to be manufactured for the object to be manufactured) during the performance of manufacturing instructions. The manufacturing reference values can be for example theoretically exact dimensions such as e.g. thread specifications, or these values are included in the manufacturing reference values. The manufacturing reference values may be directly assigned to the surfaces to be manufactured and/or to structures to be manufactured for the three-dimensional model. The manufacturing reference values and/or the three-dimensional model and/or the manufacturing instructions are preferably used to stipulate the structures to be manufactured on a workpiece (e.g. protuberances or holes to be milled) so that the object to be manufactured can be created.

In some embodiments, the manufacturing instructions can also be used for example to stipulate surface machining operations (e.g. polishing a surface or painting a surface) or work steps (e.g. oiling or greasing a milled thread) that are in particular not modellable as a structure or geometric structure to be manufactured. The manufacturing reference values may for example likewise be provided as a three-dimensional (virtual/digital) model (or three-dimensional geometry), e.g. having applicable three-dimensional coordinates (e.g. X, Y, Z).

“Manufacturing tolerance values” and the like can be understood within the context of the disclosure to mean divergences from manufacturing reference values up to which the product to be manufactured is accepted. The manufacturing tolerance values can be for example dimensional tolerances, shape and position tolerances or surface specifications, or these applicable values are included in the manufacturing tolerance values. If for example a manufacturing tolerance value is exceeded, the applicable manufactured product can be rejected, in particular, and declared as scrap. Accordingly, a manufacturing tolerance value specifies for example a threshold value on the basis of an applicable manufacturing reference value, which, when exceeded, results in the product to be manufactured being rejected. In some embodiments, each manufacturing reference value has at least one respective manufacturing tolerance value assigned to it (that is to say stored in association therewith by virtue of these values being assigned to one another e.g. via stored addresses). The manufacturing tolerance values may for example likewise be provided as a three-dimensional (virtual/digital) model (or three-dimensional geometry), e.g. having applicable three-dimensional coordinates (e.g. X, Y, Z).

“Intervention tolerance values” and the like can be understood within the context of the disclosure to mean for example divergences from manufacturing reference values that, when exceeded, admittedly still result in the product to be manufactured being accepted (that is to say not being rejected), but for example the tool and/or the manufacturing machine and/or the measuring device can still be automatically checked and/or exchanged. This avoids in particular the manufacturing tolerance values being exceeded e.g. for the object that is to be manufactured subsequently. The intervention tolerance values can be for example dimensional tolerances and/or shape and position tolerances and/or surface specifications that are specified/calculated for example as a relative/percentage value of the manufacturing tolerance values (less than 100%).

This controls a precautionary intervention in the manufacturing process so that no defective objects are manufactured. Accordingly, smaller divergences from the manufacturing reference values are permitted for the intervention tolerance values than for the manufacturing tolerance values. Accordingly, at least a portion of the manufacturing reference values preferably each (that is to say an applicable manufacturing reference value from the portion of the manufacturing reference values) have at least one assigned intervention tolerance value and/or manufacturing tolerance value. The intervention tolerance values may for example likewise be provided as a three-dimensional (virtual/digital) model (or three-dimensional geometry), e.g. having applicable three-dimensional coordinates (e.g. X, Y, Z).

“Control commands” and the like can be understood within the context of the disclosure to mean for example a program command or a CNC command that is used to control a tool (e.g. the rotation speed at which a milling cutter machines a workpiece) and/or which tool or machine tool (e.g. milling cutter, drill or 3D printer) is supposed to be used to manufacture the object to be manufactured.

“Manufacturing instructions” can be understood within the context of the disclosure to mean in particular specifications pertaining to work steps and/or manufacturing steps that cannot be expressed geometrically by the three-dimensional model. The manufacturing instructions can be used for example to stipulate surface machining operations (e.g. polishing a surface or painting a surface) or work steps (e.g. oiling or greasing a milled thread) that are in particular not modellable as a structure or geometric structure to be manufactured.

The various embodiments of the teachings herein may be useful in particular for e.g. automating a manufacturing system, since analog product definitions can be dispensed with. The manufacturing cycle or manufacturing process may be completely automated in this case. In particular, the teachings herein may reduce the time requirement for generating manufacturing reference values in the product definition (e.g. for nominal dimensions), e.g. by virtue of additional generation of visual nominal dimension specifications being dispensed with. These are in particular already defined completely/sufficiently by the geometric characteristic of the model and are therefore available e.g. for automatic computer-aided further processing, which already achieves a substantial cost saving potential within the design departments. Furthermore, in particular the decreased time requirement for providing the manufacturing information and the automated use of the three-dimensional model in the subsequent processes allow the time-to-market time to be reduced, which additionally reduces costs, for example.

Depending on the configuration of the manufacturing machine or the manufacturing system, it is possible for example for the measuring device to be realized as a separate measuring device of the manufacturing system or realized as an integral measuring device of the manufacturing machine. It is also possible for example for the manufacturing machine to comprise a further measuring device (analogously to the measuring device already mentioned).

In some embodiments, the manufacturing system can comprise multiple manufacturing machines, wherein the manufacturing system comprises a selection module that takes the three-dimensional model and the manufacturing instructions as a basis for selecting a suitable manufacturing machine for executing the manufacturing instructions. In particular, it is also possible for multiple manufacturing machines to be needed for performing the manufacturing instructions, in which case the selection module or the manufacturing system takes the manufacturing instructions and/or the three-dimensional model as a basis for determining the manufacturing machines needed therefor and if necessary controls the manufacturing process and the sequence of the machining (e.g. the sequence of the performance of the manufacturing instructions or the sequence of the manufacturing machines that perform the manufacturing instructions) of the object to be manufactured.

In some embodiments, the selection module or the manufacturing system can take the manufacturing instructions and/or the three-dimensional model as a basis for optimizing the manufacturing process while taking into consideration a stipulated criterion. By way of example, the stipulated criterion can stipulate that the manufacturing time is minimized, the manufacturing costs are minimized or the quality is maximized (that is to say the divergences from the manufacturing reference values are minimized). According to the stipulated criterion, e.g. the selection module or the manufacturing system selects appropriate manufacturing machines that comply with the stipulated criterion for the production or manufacturing process for the object to be manufactured. Once the applicable manufacturing machines have been selected, the selection module sends, e.g. using a providing apparatus (e.g. the apparatus that is likewise explained on the pages that follow), the already calculated control commands and/or the three-dimensional model and/or the manufacturing instructions to the applicable manufacturing machines.

In some embodiments, the applicable manufacturing machines can calculate the control commands on the basis of the three-dimensional model and/or the manufacturing instructions themselves. In particular, the selection module and/or the providing apparatus can also transmit to an applicable manufacturing machine just the portions of the calculated control commands and/or of the three-dimensional model and/or of the manufacturing instructions that are necessary for the applicable manufacturing machine to perform an applicable work step or manufacturing step. The particular effect achieved thereby is that unnecessarily large volumes of data are not sent and the applicable manufacturing machines can also process the smaller volumes of data more easily/more quickly.

In some embodiments, the control signal is used to control rejection of the object to be manufactured in the event of one of the applicable manufacturing tolerance values being exceeded. In some embodiments, the control signal is used to control refinishing of the object to be manufactured in the event of one of the applicable manufacturing tolerance values being exceeded. In some embodiments, the control signal is used to control production of a replacement for the object to be manufactured in the event of one of the applicable manufacturing tolerance values being exceeded.

The manufacturing system may detect early when the object to be manufactured is defective, e.g. since it has exceeded the applicable manufacturing tolerance values. As a result, it is possible to avoid taking up still further machine time for an already defective object. This improves in particular the operating efficiency of the manufacturing system.

In some embodiments, the control signal is used to control recalibration of the measuring device and/or of the manufacturing machine in the event of one of the applicable manufacturing tolerance values and/or of the applicable intervention tolerance values being exceeded. In some embodiments, the control signal is used to control fresh capture and checking of the applicable measured values in the event of one of the applicable manufacturing tolerance values and/or of the applicable intervention tolerance values being exceeded. In some embodiments, the control signal is used to control exchange of a tool in the event of one of the applicable manufacturing tolerance values and/or of the applicable intervention tolerance values being exceeded.

The manufacturing system may detect early when a worn tool is supposed to be exchanged to avoid the manufacturing tolerance values being exceeded for the object to be manufactured or for objects to be manufactured later on. As a result, it is possible in particular to avoid producing defective objects on account of worn tools. This improves in particular the operating efficiency of the manufacturing system.

In some embodiments, the manufacturing instructions are assigned to stipulated surfaces of the three-dimensional model. The manufacturing system may access the manufacturing instructions as quickly as possible. By way of example, the manufacturing instructions for manufacturing the object can therefore be grouped and split for the applicable structures to be manufactured on the workpiece. By way of example, a functional split of the manufacturing instructions can take place, for example comprising manufacturing instructions that are supposed to be carried out for surface machining operations of the same type. By way of example, the functional split of the manufacturing instructions allows one or more groups of manufacturing instructions to define sanding of the same type (e.g. sanding using a random orbit sander with sandpaper having a grit size of 2000) for different surfaces or regions of the object to be manufactured. As a result, in particular an unnecessary change of tool is avoided and the stipulated functional split of the manufacturing instructions makes it possible to quickly establish whether there are manufacturing instructions of the same type that can be performed in one work step.

In some embodiments, the control commands and/or the manufacturing instructions are used to select one or more tools, wherein in particular different tools can be selected for the stipulated surfaces of the three-dimensional model. The manufacturing system may not firmly stipulate the necessary tool for performing one of the manufacturing instructions, but rather for example allowing the tool needed for implementing the manufacturing instructions to be chosen—e.g. by the machine tool itself on the basis of defined decision criteria—when manufacturing the object. This allows for example the manufacturing process to be automated so that in particular the machine tool or the manufacturing system itself can decide what type of tool it chooses. If for example there is a stipulation that the object to be manufactured is supposed to be manufactured as cheaply as possible, but the manufacturing time is unimportant, it is possible in particular for a tool and/or type of manufacture to be chosen that takes into consideration these requirements (e.g. by virtue of the manufacturing instructions being implemented by a very robust but slowly operating milling cutter). If for example the object is supposed to be manufactured as quickly as possible, it is possible for example for a tool and/or type of manufacture to be chosen that takes into consideration these requirements (e.g. by virtue of a 3D printing method being used).

In some embodiments, the control commands and/or the manufacturing instructions are used to select one or more tools while taking into consideration a location of the manufacturing machine, wherein in particular different tools can be selected for the stipulated surfaces of the three-dimensional model. The manufacturing system may take the tools available at the location of the manufacturing machine as a basis for using a suitable tool for performing the manufacturing instructions. This avoids in particular the manufacturing instructions not being performed at the location of the manufacturing machine because the stipulated tool is currently unavailable, even though other similar tools could likewise implement the manufacturing instructions. Accordingly, the effect achieved is in particular that the manufacturing instructions are performed at the location of the manufacturing machine even if e.g. the tool originally defined in the manufacturing instructions is not available at the location, but these manufacturing instructions can also be executed by a different tool for manufacturing the object.

In some embodiments, an appropriate tool is selected on the basis of the associated manufacturing reference values and/or the manufacturing tolerance values and/or the intervention tolerance values. The manufacturing system may choose tools that for example cause as small as possible a divergence from the manufacturing reference values. By way of example, the measured values can additionally be taken into consideration for the selection. If for example as many objects as possible are supposed to be manufactured in a short time, it is possible to choose a tool that has hitherto had very small divergences from the manufacturing reference values and hence can be used for a long time, for example, before it is changed. In the same way, it is for example also possible to choose a manufacturing machine that has hitherto produced very small divergences from the manufacturing reference values, meaning that the manufacturing process is not interrupted by a maintenance interval, for example.

In some embodiments, the three-dimensional model is transmitted from a providing apparatus to the manufacturing system and/or the manufacturing machine and/or the measuring device. The manufacturing system may provide the three-dimensional model via a bus and/or a communication network. The providing apparatus may be for example a transmitting apparatus, or a distributed database or a distributed data structure that transmits the whole or part of the three-dimensional model to the measuring device and/or the manufacturing machine.

In some embodiments, the manufacturing instructions take into consideration necessary prerequisites for subsequent manufacturing instructions. The manufacturing system may be able to take into consideration prerequisites for a manufacturing machine to perform the manufacturing instructions during manufacture. These prerequisites can stipulate a sequence of machining steps for the object to be manufactured or define material protrusions that are e.g. necessary for the next processing step. A manufacturing machine rates or takes into consideration these prerequisites, for example, and leaves enough material over during the performance of a first manufacturing instruction for e.g. one or more subsequent manufacturing instructions to still be able to be performed to manufacture the object. The applicable prerequisites may be stored in the manufacturing instructions or included in the manufacturing instructions, for example.

In some embodiments, the manufacturing instructions and the three-dimensional model stipulate structures to be manufactured for the object to be manufactured. The manufacturing system may stipulate the structures to be manufactured (e.g. three-dimensional geometric structures) for the object to be manufactured. The manufacturing instructions comprise for example instructions and/or specifications and/or stipulations so that structures to be manufactured (e.g. geometric structures such as protuberances, surface machining operations such as sanding or coating) can be manufactured at the stipulated positions on the object to be manufactured. In particular, the applicable positions of the structures to be manufactured on the three-dimensional model correspond to the positions of the structures that are created on the object to be manufactured. In other words, the structures to be manufactured are therefore spatially or geometrically mapped out by the stipulated positions on the three-dimensional model itself by means of the manufacturing instructions, wherein the stipulated positions on the three-dimensional model correspond to the real positions of the structures to be manufactured on the object to be manufactured.

In some embodiments, the selection of an appropriate tool is optimized on the basis of the associated manufacturing reference values and/or the manufacturing tolerance values and/or the intervention tolerance values. The manufacturing system may optimize the manufacture of the object to be manufactured on the basis of a stipulated criterion. By way of example, the stipulated criterion can stipulate that the manufacturing time is minimized, the manufacturing costs are minimized or the quality is maximized (that is to say the divergences from the manufacturing reference values are minimized). By way of example, minimizing the manufacturing costs can involve a less precise, and hence cheap, tool being chosen. By way of example, minimizing the manufacturing time can involve a precise and/or better tool being chosen that has a high processing speed. By way of example, optimization can also be performed for an applicable stipulated surface/position/structure and the associated manufacturing reference values and/or the manufacturing tolerance values and/or the intervention tolerance values. By way of example, increasing the quality of the object to be manufactured can involve a precise and/or better tool being chosen that has or permits a higher manufacturing accuracy.

In some embodiments, there is an apparatus having: a providing module for providing a three-dimensional model, wherein the three-dimensional model comprises manufacturing instructions for a manufacturing machine, the three-dimensional model and the manufacturing instructions are used by the manufacturing machine to calculate control commands; and the three-dimensional model, the manufacturing instructions and the control commands are used to configure the manufacturing machine such that an object corresponding to the three-dimensional model is manufactured.

The apparatus may transmit or send the three-dimensional model to the manufacturing system and/or the manufacturing machine and/or the measuring device. In this regard, for example the providing module may be in the form of a communication module. The apparatus may be for example a distributed database, such as for example a blockchain, a peer-to-peer database or a cloud service. In some embodiments, the providing module may authenticate a receiver of the three-dimensional model so that in particular it is ensured that e.g. only authorized receivers (e.g. the manufacturing system and/or the manufacturing machine and/or the measuring device) receive the three-dimensional model.

In some embodiments, the receivers exchange with the apparatus (security) credentials necessary therefor (e.g. cryptographic keys, digital signatures or passwords) or other data suitable therefore, which e.g. are checked by the apparatus. In some embodiments, the providing module can transmit to an applicable receiver just the necessary portions of the data of the three-dimensional model that are necessary for executing the applicable manufacturing instructions or the checking. In this regard, for example applicable receiver-specific profiles may be stored in a configuration memory of the apparatus, which e.g. specify which portions of the data (e.g. manufacturing reference values and/or the manufacturing tolerance values and/or the intervention tolerance values and/or the manufacturing instructions, etc.) of the three-dimensional model can be transmitted for which receiver. It is for example also conceivable for the applicable receivers to transmit the size of the data they require from the three-dimensional model (e.g. to the apparatus) in automated fashion. This is effected for example during the installation of receivers in the manufacturing system or during maintenance of the manufacturing system or when the manufacturing system has been put into a configuration mode.

In some embodiments, the respective manufacturing instructions have manufacturing reference values and/or manufacturing tolerance values and/or intervention tolerance values assigned to them, wherein in particular the intervention tolerance values permit a smaller divergence from manufacturing reference values than the manufacturing tolerance values. The apparatus may transmit or send the three-dimensional model with the manufacturing instructions (e.g. manufacturing data) to the manufacturing system and/or the manufacturing machine and/or the measuring device. If a three-dimensional model has a very high volume of data, the apparatus can provide for example only the necessary portion of the data of the three-dimensional model for the manufacturing system and/or the manufacturing machine and/or the measuring device.

In some embodiments, measured values for the object to be manufactured are captured by a measuring device, wherein the manufacturing reference values and/or the manufacturing tolerance values and/or intervention tolerance values are used to configure the measuring device such that a divergence of measured values from the applicable manufacturing tolerance values and an exceeding of the associated manufacturing tolerance values and/or the associated intervention tolerance values result in a control signal being provided.

In some embodiments, there is a manufacturing machine comprising: a first communication module for receiving a three-dimensional model and/or control commands, wherein the three-dimensional model comprises manufacturing instructions for the manufacturing machine; in particular a calculating module, wherein the calculating module uses the three-dimensional model and the manufacturing instructions to calculate control commands; a manufacturing module, wherein the three-dimensional model, the manufacturing instructions and the control commands are used to configure the manufacturing machine such that an object corresponding to the three-dimensional model is manufactured.

In some embodiments, the manufacturing machine comprises at least one further feature or multiple further features in order to analogously reproduce embodiments (e.g. functional features) of the manufacturing system and/or the measuring device.

In some embodiments, there is a measuring device comprising: a second communication module for receiving a three-dimensional model, wherein the three-dimensional model comprises manufacturing instructions, the respective manufacturing instructions have manufacturing reference values and/or manufacturing tolerance values and/or intervention tolerance values assigned to them; a capture module, wherein the capture module uses sensors to capture measured values for a manufactured object, the object is manufactured on the basis of the three-dimensional model and the manufacturing instructions, the measured values are captured in each case for the manufacturing reference values and/or the manufacturing tolerance values and/or intervention tolerance values; and a checking module, wherein in particular the measured values are used to check whether the manufactured object complies with the reference values and/or the tolerance values, in particular the measured values are compared against the reference values and/or the tolerance values, in particular a divergence of the measured values from the applicable manufacturing reference values and an exceeding of the associated manufacturing tolerance values and/or the associated intervention tolerance values result in a control signal being provided.

In some embodiments, the measuring device comprises at least one further feature or multiple further features in order to analogously reproduce embodiments (e.g. functional features) of the manufacturing system and/or the manufacturing machine.

In some embodiments, there is a method for the computer-aided manufacture of an object by means of a manufacturing machine, having the following method steps: receiving a three-dimensional model and/or control commands, wherein the three-dimensional model comprises manufacturing instructions for the manufacturing machine; and manufacturing an object corresponding to the three-dimensional model, wherein the three-dimensional model, the manufacturing instructions and the control commands are used to configure the manufacturing machine such that the object is manufactured.

In some embodiments, the method comprises at least one further feature or multiple further features in order to analogously reproduce embodiments (e.g. functional features) of the manufacturing machine.

In some embodiments, there is a method for the computer-aided checking of an object manufactured by means of a manufacturing machine and/or of a manufacturing machine, having the following method steps: receiving a three-dimensional model, wherein the three-dimensional model comprises manufacturing instructions, the respective manufacturing instructions have manufacturing reference values and/or manufacturing tolerance values and/or intervention tolerance values assigned to them; capturing measured values, wherein the measured values are captured for the manufactured object by means of sensors, the object is manufactured on the basis of the three-dimensional model and the manufacturing instructions, the measured values are captured in each case for the manufacturing reference values and/or the manufacturing tolerance values and/or the intervention tolerance values; and checking the measured values, wherein in particular the measured values are used to check whether the manufactured object complies with the reference values and/or the tolerance values, in particular the measured values are compared against the reference values and/or the tolerance values, in particular a divergence of the measured values from the applicable manufacturing reference values and an exceeding of the associated manufacturing tolerance values and/or the associated intervention tolerance values result in a control signal being provided.

In some embodiments, the method comprises at least one further feature or multiple further features in order to analogously reproduce embodiments (e.g. functional features) of the measuring device.

In some embodiments, there is a method for the computer-aided manufacture of an object by means of a manufacturing machine, having the following method steps: receiving a three-dimensional model and/or control commands, wherein the three-dimensional model comprises manufacturing instructions, the respective manufacturing instructions have manufacturing reference values and/or manufacturing tolerance values assigned to them; manufacturing an object corresponding to the three-dimensional model, wherein the three-dimensional model, the manufacturing instructions and the control commands are used to configure the manufacturing machine such that the object is manufactured; capturing measured values, wherein the measured values are captured for the manufactured object by means of sensors, the measured values are captured in each case for the manufacturing reference values and/or the manufacturing tolerance values and/or the intervention tolerance values; and checking the measured values, wherein the measured values are used to check whether the manufactured object complies with the reference values and/or the tolerance values, in particular the measured values are compared against the reference values and/or the tolerance values, in particular a divergence of the measured values from the applicable manufacturing reference values and an exceeding of the associated manufacturing tolerance values and/or the associated intervention tolerance values result in a control signal being provided.

In some embodiments, the method comprises at least one further feature or multiple further features in order to analogously reproduce embodiments (e.g. functional features) of the manufacturing system.

In some embodiments, a computer program product having program commands for performing the cited methods is claimed, wherein the computer program product can be used to perform in each case one of the methods described herein, all of the methods, or a combination of the methods.

In some embodiments, a variant of the computer program product having program commands for configuring a creating device, for example a 3D printer, a computer system or a production machine suitable for creating processors and/or devices, is claimed, wherein the creating device is configured by means of the program commands such that the apparatus and/or the manufacturing system and/or the manufacturing machine and/or the measuring device is created. Furthermore, a providing apparatus for storing and/or providing the computer program product is claimed. The providing apparatus is for example a data carrier that stores and/or provides the computer program product. In some embodiments, the providing apparatus is for example a network service, a computer system, a server system, in particular a distributed computer system, a cloud-based computer system and/or virtual computer system, which stores and/or provides the computer program product preferably in the form of a data stream.

This providing is effected for example as a download in the form of a program data block and/or command data block, preferably as a file, in particular as a download file, or as a data stream, in particular as a download data stream, of the complete computer program product. This providing can for example alternatively be effected as a partial download that consists of multiple portions and in particular is downloaded via a peer-to-peer network or provided as a data stream. Such a computer program product is read into a system, for example using the providing apparatus in the form of the data carrier, and executes the program commands, so that the method according to the invention is executed on a computer or configures the creating device such that it creates the apparatus and/or the manufacturing system and/or the manufacturing machine and/or the measuring device as described herein.

Unless indicated otherwise or indicated already, the exemplary embodiments below have at least one processor and/or one memory unit in order to implement or carry out the method. Moreover, in particular a (relevant) person skilled in the art, with knowledge of the method claim/method claims, is of course aware of all routine possibilities for producing products or possibilities for implementation in the prior art, and so there is no need in particular for independent disclosure in the description. In particular, these customary realization variants known to a person skilled in the art can be produced exclusively by hardware (components) or exclusively by software (components). In some embodiments, a person skilled in the art, within the scope of his/her expert ability, can chose to the greatest possible extent arbitrary combinations for hardware (components) and software (components) in order to implement realization variants incorporating teachings of the present disclosure. A combination for hardware (components) and software (components) can occur in particular if one portion of the effects is brought about exclusively by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of the teachings herein to name all these realization possibilities. In this respect, in particular all the exemplary embodiments below are intended to demonstrate merely by way of example a few ways in which in particular such realizations of the teaching according to the invention could be manifested.

Consequently, in particular the features of the individual exemplary embodiments are not restricted to the respective exemplary embodiment, but rather relate to the teachings in general. Accordingly, features of one exemplary embodiment can also serve as features for another exemplary embodiment, in particular without this having to be explicitly stated in the respective exemplary embodiment.

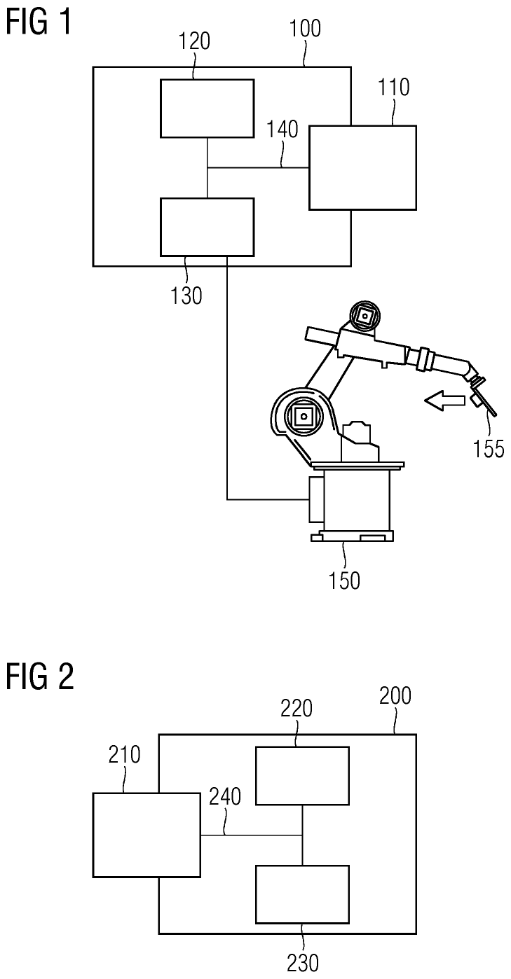

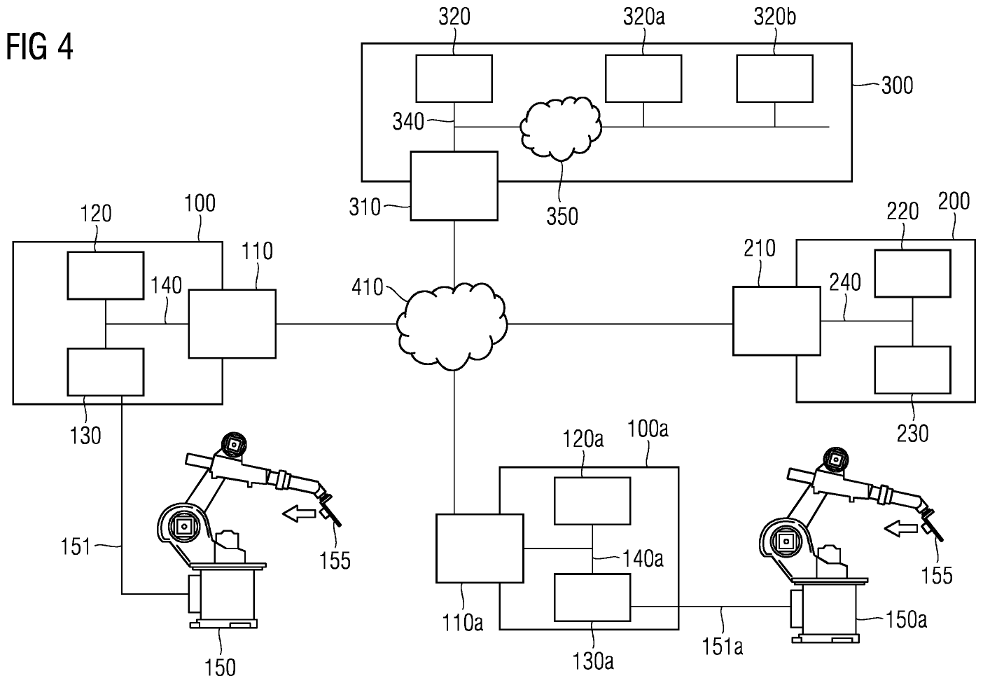

FIGS. 1-3 show individual components (manufacturing machine 100 (e.g. a turning machine, a milling machine, a turn-mill center, a sanding machine), measuring device 200 (e.g. a coordinate measuring device, laser scanner), apparatus 300 (e.g. an apparatus having CAD software, PDM/PLM system/software, CAM software, CMM software, DNC server, CAQ software)) of a manufacturing system. The manufacturing system can be the manufacturing system from FIG. 4, for example.

The manufacturing machine 100 comprises a first communication module 110, an optional calculating module 120 and a manufacturing module 130, which are communicatively connected to one another via a bus 140.

The calculating module 120 may be in the form of an independent calculating module of the manufacturing system or may be included in the apparatus 300 or may be included in the manufacturing machine, depending on the implementation, for example.

The manufacturing machine 100 can for example additionally also comprise a further or multiple further component/s, such as for example a processor, a memory unit, further communication interfaces (e.g. Ethernet, WLAN), an input device, in particular a computer keyboard or a computer mouse, and a display device (e.g. a monitor), and an input/output unit for connecting sensors and/or tools and/or actuators. The processor can comprise for example multiple further processors, which can be used in particular to realize further exemplary embodiments. The cited components or further component/s may likewise be communicatively connected to one another via the bus 140, for example.

The processor can be for example an ASIC realized on an application-specific basis for the functions of a respective module (or a unit) or of all the modules of the exemplary embodiment (and/or of further exemplary embodiments), the program component or the program commands being realized in particular as integrated circuits. The processor can also be for example an FPGA that is configured in particular by means of the program commands such that the FPGA performs the functions of a respective module or of all the modules of the exemplary embodiment (and/or of further exemplary embodiments).

The first communication module 110 is designed to receive a three-dimensional model and/or control commands. The three-dimensional model comprises manufacturing instructions, wherein the respective manufacturing instructions have manufacturing reference values and/or manufacturing tolerance values and/or intervention tolerance values assigned to them.

If for example control commands are received and are not calculated by the manufacturing machine 100 itself, the control commands are control commands that were calculated for the manufacturing machine 100 on the basis of the three-dimensional model and the manufacturing instructions. In particular, these control commands are calculated on a device-specific basis. In other words, they are in particular device-specific control commands.

The first communication module 110 may be for example a network interface (WLAN or wired) by means of which the three-dimensional model is transmitted/sent to the manufacturing machine 100, for example by the apparatus 300. The three-dimensional model in this instance stipulates for example the geometry or the structures to be manufactured for the object to be manufactured, e.g. by means of the applicable manufacturing reference values. The manufacturing instructions stipulate for example when what type of machining is used by the manufacturing machine to create the structures to be manufactured, e.g. by means of a tool. The applicable manufacturing tolerance values specify in particular what divergences are accepted for an applicable manufacturing reference value for the object to be manufactured in the case of a manufactured structure without considering the object to be manufactured (e.g. a workpiece) defective.

The manufacturing instructions in this instance are assigned to surfaces or to structures to be manufactured that are stipulated by the three-dimensional model or modeled thereby. This is effected for example by storing an applicable data record, which may be assigned to the applicable surfaces or structures to be manufactured via an address or a unique identifier.

The manufacturing reference values and/or the manufacturing tolerance values and/or the intervention tolerance values may for example be assigned to the surfaces or the structures to be manufactured. The manufacturing reference values can for example stipulate or define the surfaces or the structures to be manufactured in an assigned manner. Accordingly, the manufacturing instructions may have the manufacturing reference values and/or the manufacturing tolerance values and/or the intervention tolerance values assigned to them. Depending on the implementation, the manufacturing instructions can also comprise the manufacturing reference values and/or the manufacturing tolerance values and/or the intervention tolerance values. In some embodiments, the manufacturing reference values can also comprise the manufacturing instructions and/or the manufacturing tolerance values and/or the intervention tolerance values.

The calculating module 120 is designed to calculate control commands on the basis of the three-dimensional model and the manufacturing instructions. When calculating the control commands, e.g. the three-dimensional model and the manufacturing instructions are used to determine which tools and/or which CNC commands are necessary to produce the workpiece to be manufactured or how an applicable tool for producing a structure to be manufactured (e.g. a drill hole) needs to be controlled so that e.g. the manufacturing tolerance values are complied with. This also involves for example control commands being calculated for how a tool needs to be spatially oriented so that an applicable structure can be manufactured.

By way of example, the control commands can be used to control a robot 150 that uses a tool 155 to produce the object to be manufactured or a structure to be manufactured on a workpiece. The manufacturing machine 100 in this instance can comprise the robot 150 and select the appropriate tool 155 for the robot so that the object to be manufactured can be created.

For tool selection, the manufacturing machine can comprise for example a tool database by means of which the available tools can be managed. The tool database can provide for example tool properties necessary for a tool selection. The tool properties may be for example how high/great the divergences from the manufacturing reference value of an applicable tool are if the applicable tool is used to machine a workpiece. In some embodiments, for example costs of use, energy consumption or a machining speed of the applicable tool may be stored or included in the tool properties. These tool properties can be taken into consideration for example when optimizing the manufacturing instructions or the manufacturing process for the object to be manufactured.

New or exchanged tools can be stored in the tool database or else a used tool can be removed from the database. This may be performed in automated fashion by virtue of the applicable tools being equipped with or comprising appropriate data processing devices and/or data communication devices (e.g. RFID chips) that comprise (that is to say store) the tool properties for an applicable tool and are preferably stored in the tool database in automated fashion by an applicable communication device (e.g. an RFID reader). If for example it is detected that e.g. there is a drop below a stipulated minimum value for replacement tools (e.g. a minimum value of 3), an order for further replacement tools can be prompted for example in automated fashion by the tool database.

In a variant in which the calculating module 120 is for example in the form of a separate calculating module of the manufacturing system, the calculating module 120 comprises for example an appropriate communication module in order to receive the three-dimensional model and/or the manufacturing instructions and to transmit the calculated (device-specific) control commands to a manufacturing machine (e.g. the manufacturing machine 100). The manufacturing system preferably undertakes the selection of the applicable manufacturing machine and controls the transmission of the applicable data.

The communication module of the calculating module 120 may be a network interface (WLAN or wired), for example. In a variant in which the calculating module 120 is included in the apparatus 300, for example, the three-dimensional model and/or the manufacturing instructions can be transmitted to the calculating module 120 via the bus 340. Accordingly, the calculating module 120 can transmit the calculated (device-specific) control commands to the applicable manufacturing machine (e.g. the manufacturing machine 100) by means of the communication module 310 of the apparatus 300.

In some embodiments, the control commands are stored in the three-dimensional model (or by the three-dimensional model). In this case, the applicable manufacturing instructions then preferably comprise the applicable control commands that were calculated for these or applicable manufacturing instructions. In particular, this produces a three-dimensional model that is specific to the applicable control commands (which e.g. can be referred to as a control-command-specific three-dimensional model). In some embodiments, a corresponding control-command-specific three-dimensional model can comprise addressing for an applicable manufacturing machine, e.g. by virtue of manufacturing machines each comprising a UID and the applicable UID of the chosen manufacturing machine likewise being included in or stored by the three-dimensional model. A three-dimensional model of this kind may be for example a manufacturing-machine-specific three-dimensional model.

The manufacturing module 130 is designed to use the three-dimensional model, the manufacturing instructions, and the control commands to configure the manufacturing machine such that an object corresponding to the three-dimensional model is manufactured. In this regard, the manufacturing machine 100 and/or the manufacturing module 130 can comprise an additional communication interface (or can use the first communication module 110) e.g. in order to control the robot 150 so that it chooses the appropriate tool 155 for performing the manufacturing instructions and machines an applicable workpiece using the tool 155.

The measuring device 200 comprises a second communication module 210, a capture module 220 and a checking module 230, which are communicatively connected to one another via a bus 240. The measuring device 200 can for example additionally also comprise a further or multiple further component/s, such as for example a processor, a memory unit, further communication interfaces (e.g. Ethernet, WLAN), an input device, in particular a computer keyboard or a computer mouse, and a display device (e.g. a monitor), and an input/output unit for connecting sensors and/or tools and/or actuators. The processor can comprise for example multiple further processors, which can be used in particular to realize further exemplary embodiments. The cited components or further component/s may likewise be communicatively connected to one another via the bus 240, for example.

The processor can be for example an ASIC realized on an application-specific basis for the functions of a respective module (or a unit) or of all the modules of the exemplary embodiment (and/or of further exemplary embodiments), the program component or the program commands being realized in particular as integrated circuits. The processor can also be for example an FPGA that is configured in particular by means of the program commands such that the FPGA performs the functions of a respective module or of all the modules of the exemplary embodiment (and/or of further exemplary embodiments).

The second communication module is designed to receive the three-dimensional model. The second communication module 210 can be for example a network interface (WLAN or wired) by means of which the three-dimensional model is transmitted/sent to the measuring device 200, for example by the apparatus 300.

The three-dimensional model in this instance stipulates for example the geometry or the structures to be manufactured for the object to be manufactured, e.g. by means of the applicable manufacturing reference values. The manufacturing instructions stipulate for example when what type of machining is used by the manufacturing machine to create the structures to be manufactured, e.g. by means of a tool. The applicable manufacturing tolerance values specify in particular what divergences are accepted for an applicable manufacturing reference value for the object to be manufactured in the case of a manufactured structure without considering the object to be manufactured (e.g. a workpiece) defective.

The intervention tolerance values specify in particular when intervention is required in a manufacturing process for manufacturing an object, for example in order to change a tool so that the manufacturing tolerance values are prevented from being exceeded. This can also happen (or may be preconfigured) for example when the machining of an object is complete, so that in particular a tool change takes place before a new object is machined.

The capture module 120 is designed to use sensors to capture measured values for the manufactured object. The measured values are captured in each case for the applicable manufacturing reference values of for example a manufactured structure and/or for the whole object to be manufactured. The sensors may be for example 3D scanners and/or surface microscopes and/or 3D cameras.

If for example the manufacturing machine 100 comprises the measuring device 200, the sensors may for example also be corresponding sensors (e.g. measuring probes or laser scanners) of the manufacturing machine 100 that have the measuring device 200 communicatively connected to them.

The checking module 130 is designed to use the measured values to check whether the manufactured object complies with the manufacturing reference values. In other words, e.g. a check is performed to determine whether the applicable measured values diverges from the applicable manufacturing reference values for the manufactured object or a manufactured structure of the object from the manufacturing reference values.

If for example a divergence of the measured values from the applicable manufacturing reference values is found, a check is performed to determine whether the measured values comply with or exceed the associated manufacturing tolerance values and/or the associated intervention tolerance values. If such an exceeding is found, one or more control signals are provided. As a result, in particular a check is performed to determine whether the manufactured object complies with the manufacturing reference values. Should divergences of the measured values from the manufacturing reference values be detected or ascertained, but they are within the manufacturing tolerance values, or the measured values correspond to the manufacturing reference values, the object to be manufactured is accepted as a valid object.

In some embodiments, the control signal is used to control rejection of the object to be manufactured in the event of one of the applicable manufacturing tolerance values being exceeded. In some embodiments, the control signal is used to control refinishing of the object to be manufactured in the event of one of the applicable manufacturing tolerance values being exceeded. In some embodiments, the control signal is used to control production of a replacement for the object to be manufactured in the event of one of the applicable manufacturing tolerance values being exceeded. In some embodiments, the control signal is used to control recalibration of the measuring device and/or of the manufacturing machine in the event of one of the applicable manufacturing tolerance values and/or of the applicable intervention tolerance values being exceeded. In some embodiments, the control signal is used to control fresh capture and checking of the applicable measured values in the event of one of the applicable manufacturing tolerance values and/or of the applicable intervention tolerance values being exceeded. In some embodiments, the control signal is used to control exchange of a tool in the event of one of the applicable manufacturing tolerance values and/or of the applicable intervention tolerance values being exceeded. In some embodiments, a further control signal is provided in the event of the applicable manufacturing tolerance values and/or the applicable intervention tolerance values being complied with.

The further control signal or the control signal can for example also comprise an indication/data record indicating the extent to which the applicable measured values diverge from the associated manufacturing reference values, for example in order to determine an indication of quality for the manufacturing object or to determine an indication of quality for the manufacturing machine.

The apparatus 300 comprises a providing module 310 for providing the three-dimensional model. The apparatus can transmit or send the three-dimensional model to the manufacturing system and/or the manufacturing machine and/or the measuring device. The three-dimensional model may be stored by a memory module 320, for example. The providing module 310 retrieves the portion of the three-dimensional model (e.g. from the memory module 320) that is needed by the measuring device 200 and/or the manufacturing machine 100.

The providing module 320 may be in the form of a communication module (e.g. a network interface), for example. The apparatus 300 may be for example a distributed database, such as for example a blockchain, a peer-to-peer database or a cloud service. In some embodiments, the providing module may be designed to authenticate a receiver of the three-dimensional model so that in particular it is ensured that e.g. only authorized receivers (e.g. the manufacturing system and/or the manufacturing machine and/or the measuring device) receive the three-dimensional model. In this regard, it is possible in particular for the receivers to exchange with the apparatus (security) credentials necessary therefor (e.g. cryptographic keys, digital signatures or passwords), which e.g. are checked by the apparatus.

In some embodiments, the providing module can transmit to an applicable receiver just the necessary portions of the data of the three-dimensional model that are necessary for executing the applicable manufacturing instructions or the checking. In this regard, for example applicable receiver-specific profiles may be stored in a configuration memory of the apparatus, which e.g. specify which portions of the data (e.g. manufacturing reference values and/or the manufacturing tolerance values and/or the intervention tolerance values and/or the manufacturing instructions, etc.) of the three-dimensional model can be transmitted for which receiver. It is for example also conceivable for the applicable receivers to transmit the size of the data they require from the three-dimensional model in automated fashion. This can be effected for example during the installation of receivers in the manufacturing system or during maintenance of the manufacturing system or when the manufacturing system has been put into a configuration mode. Depending on the implementation, the three-dimensional model with the applicable data (control commands and/or manufacturing reference values and/or manufacturing tolerance values and/or intervention tolerance values and/or manufacturing instructions) can be retrieved for example from the measuring device 200 and/or the manufacturing machine 100 and/or the manufacturing system by means of the providing module 310.

In some embodiments, just the portions of the three-dimensional model that the respective measuring device 200 and/or the respective manufacturing machine 100 and/or the respective manufacturing system need for performing manufacturing instructions or work processes/manufacturing steps to be retrieved with the applicable data by the measuring device 200 and/or the manufacturing machine 100 and/or the manufacturing system.

By way of example, when drilling a hole (that is to say performing the applicable manufacturing instructions) at a specific point on the object to be manufactured (which is determined or stipulated on the basis of the three-dimensional model), for example the (spatial) area that is necessary for performing this work process/manufacturing step is transmitted with the associated data of the three-dimensional model to an applicable manufacturing machine (e.g. manufacturing machine 100). In other words, this is accomplished by virtue of for example the apparatus generating a partial model for the applicable receivers or retrievers with the associated data and transmitting it to the receivers and/or the retrievers.

The apparatus 300 can for example additionally also comprise a further or multiple further component/s, such as for example a processor, a memory unit, further communication interfaces (e.g. Ethernet, WLAN), an input device, in particular a computer keyboard or a computer mouse, and a display device (e.g. a monitor), and an input/output unit for connecting sensors and/or tools and/or actuators. The processor can comprise for example multiple further processors, which can be used in particular to realize further exemplary embodiments. The cited components or further component/s may likewise be communicatively connected to one another via the bus 340, for example.

The processor can be for example an ASIC realized on an application-specific basis for the functions of a respective module (or a unit) or of all the modules of the exemplary embodiment (and/or of further exemplary embodiments), the program component or the program commands being realized in particular as integrated circuits. The processor can also be for example an FPGA that is configured in particular by means of the program commands such that the FPGA performs the functions of a respective module or of all the modules of the exemplary embodiment (and/or of further exemplary embodiments).

The manufacturing machine 100, the measuring device 200 and apparatus 300 are for example communicatively connected to one another in the manufacturing system from FIG. 4 via a communication network 410. In some embodiments, the manufacturing system from FIG. 4 can comprise a further manufacturing machine 100a. The further manufacturing machine 100a likewise comprises for example a further communication module 110a, a further calculating module 120a and a manufacturing module 130a, which are connected to one another via a further bus 140a. The further manufacturing system 100a also comprises a further robot 150a and a further tool 155a.

Depending on the configuration of the manufacturing machine 100 or the manufacturing system, it is possible for example for the measuring device 200 to be realized as a separate measuring device of the manufacturing system or realized as an integral measuring device of the manufacturing machine 100. It is also possible for example for the manufacturing machine 100 to comprise a further measuring device 200 (analogously to the measuring device already mentioned).

The manufacturing system can for example also comprise multiple manufacturing machines 100, 100a, wherein the manufacturing system comprises a selection module that takes the three-dimensional model and the manufacturing instructions as a basis for selecting a suitable manufacturing machine for executing the manufacturing instructions. In some embodiments, the selection can involve the applicable manufacturing reference values and/or the applicable manufacturing tolerance values and/or the applicable intervention tolerance values. The selection module can comprise, analogously to the calculating module 120, a communication module that is used to send and/or receive the accordingly made selection or the necessary data for making a selection. The communication module may be for example a network interface (WLAN or wired).

In some embodiments, it is also possible for multiple manufacturing machines 100, 100a to be needed for performing the manufacturing instructions, (e.g. the manufacturing machine 100 mills grooves into a workpiece and the further manufacturing machine 100a polishes the milled grooves), in which case the selection module or the manufacturing system takes the manufacturing instructions and/or the three-dimensional model as a basis for determining the manufacturing machines needed therefor and if necessary controls the manufacturing process and the sequence of the machining (e.g. the sequence of the performance of the manufacturing instructions or the sequence of the manufacturing machines that perform the manufacturing instructions) of the object to be manufactured. In particular, the selection module or the manufacturing system can take the manufacturing instructions and/or the three-dimensional model as a basis for optimizing the manufacturing process on the basis of a stipulated criterion. By way of example, the stipulated criterion can stipulate that the manufacturing time is minimized, the manufacturing costs are minimized or the quality is maximized (that is to say the divergences from the manufacturing reference values are minimized). According to the stipulated criterion, e.g. the selection module or the manufacturing system selects appropriate manufacturing machines that comply with the stipulated criterion for the production or manufacturing process for the object to be manufactured.

For the purpose of selecting the necessary manufacturing machines, the manufacturing system can comprise for example a manufacturing machine database by means of which the available manufacturing machines can be managed. The manufacturing machine database can provide for example manufacturing machine properties necessary for a manufacturing machine selection. The manufacturing machine properties may be for example how great the divergences from the manufacturing reference value of an applicable manufacturing machine are if an applicable manufacturing machine machines a workpiece. In some embodiments, for example costs of use, energy consumption or a machining speed of the applicable manufacturing machine may be stored or included in the manufacturing machine properties. These manufacturing machine properties can be taken into consideration for example when optimizing the manufacturing instructions or the manufacturing process for the object to be manufactured. Additionally, the manufacturing machine properties can also comprise an address and/or UID of an applicable manufacturing machine, which e.g. can be used to communicate with an applicable manufacturing machine. This address can be used for example to transmit the three-dimensional model and the associated data to the selected manufacturing machines.

In this regard, applicable manufacturing machines can register with the manufacturing machine database by using a network protocol. This is preferably performed in automated fashion by virtue of the applicable manufacturing machines storing their respective manufacturing machine properties in a memory module and transmitting them to the manufacturing machine database (e.g. at stipulated times, on an interval-driven basis, when a manufacturing machine is switched on or when manufacturing machine properties of a respective manufacturing machine change). The manufacturing machine properties can also comprise for example the value/degree of the divergences from the applicable manufacturing reference values (and/or the applicable manufacturing tolerance values and/or the applicable intervention tolerance values) and/or the absolute measured values and/or the relative measured values and/or the absolute divergences from the manufacturing reference values (and/or the applicable manufacturing tolerance values and/or the applicable intervention tolerance values) and/or the relative divergences from the manufacturing reference values (and/or the applicable manufacturing tolerance values and/or the applicable intervention tolerance values). This can also include applicable divergences for tools of a respective manufacturing machine. Alternatively or additionally, the manufacturing machine properties can also comprise further information indicating for example the number of defective manufactured objects within a stipulated period (e.g. within one month) or indicating the number of defectively manufactured objects compared with the accepted/non-defectively manufactured objects (e.g. on average one defectively manufactured object is produced in 100 manufactured objects).

In some embodiments, the explanations cited here for the selection module for manufacturing machines and/or the manufacturing machine database apply in an analogous fashion to a selection module for measuring devices and/or for a measuring device database. Measuring device properties can likewise comprise an address and/or a UID and/or details pertaining to the sensors (e.g. type of the sensors such as surface scanner, 3D camera, etc.) and/or details pertaining to the accuracy of the sensors.

In variants in which the calculating module 120 is in the form of a separate calculating module of the manufacturing system, for example, the selection module may be an integral module of the calculating module or the calculating module 120 is an integral module of the selection module. In some embodiments, the apparatus 300 comprises the selection module. In some embodiments, in which the calculating module 120 is included in the apparatus 300, for example, the selection module may be an integral module of the calculating module 120 or the calculating module 120 is an integral module of the selection module.

The calculating module 120 calculates the control commands for example specifically for an applicable manufacturing machine (e.g. the manufacturing machines 100) or a specific class of manufacturing machines (such as e.g. drilling machines, milling machines, etc.) and controls the selection module accordingly so that the accordingly suitable manufacturing machine (that is to say the manufacturing machine for which the control commands were calculated) is selected by the selection module. Alternatively, the selection module can take the calculated control commands or can take the manufacturing instructions and/or the three-dimensional model as a basis for selecting an applicable manufacturing machine. The applicable selection is then transmitted to the calculating module 120 and the calculating module 120 can then calculate the control commands.

The apparatus 300 from FIG. 4 may comprise a distributed database system whose individual nodes or memory modules (e.g. the memory module 320, a first memory module 320a and a second memory module 320b) are connected to one another via a further communication network 350. The individual nodes or the individual memory modules then preferably each store the whole or part of the three-dimensional model. The distributed database system preferably stores the whole of the three-dimensional model.

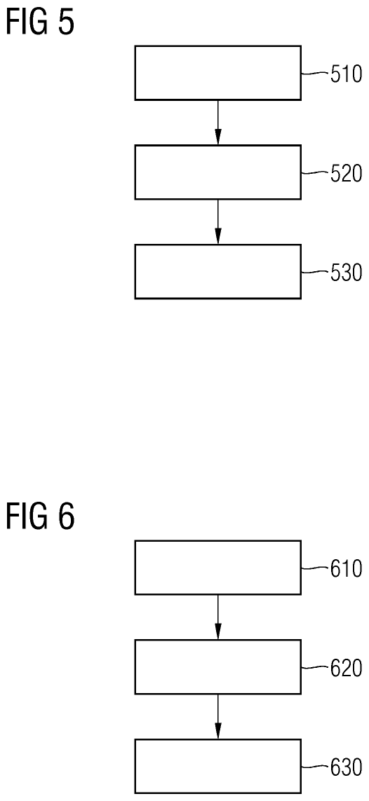

FIG. 5 shows a further exemplary embodiment of the teachings herein. Specifically, FIG. 5 shows a flowchart of an example method implemented as a computer-aided method. Specifically, a method for the computer-aided manufacture of an object by means of a manufacturing machine is shown in this exemplary embodiment.

The method comprises a first method step 510 for receiving a three-dimensional model and/or control commands, wherein the three-dimensional model comprises manufacturing instructions for the manufacturing machine.

The method comprises a second method step 520 for calculating control commands by means of the three-dimensional model and the manufacturing instructions. Depending on the chosen implementation variant, the second method step is optional.

The method comprises a third method step 530 for manufacturing an object corresponding to the three-dimensional model, wherein the three-dimensional model, the manufacturing instructions and the control commands are used to configure the manufacturing machine such that the object is manufactured.

FIG. 6 shows a further exemplary embodiment of the teachings herein. Specifically, FIG. 6 shows a flowchart of an example method implemented as a computer-aided method. Specifically, a method for the computer-aided checking of an object manufactured by means of a manufacturing machine and/or of a manufacturing machine is depicted in this exemplary embodiment.

The method comprises a first method step 610 for receiving a three-dimensional model, wherein the three-dimensional model comprises manufacturing instructions and the respective manufacturing instructions have manufacturing reference values and/or manufacturing tolerance values and/or intervention tolerance values assigned to them.

The method comprises a second method step 620 for capturing measured values, wherein the measured values are captured for the manufactured object by means of sensors. In this instance the object has been manufactured (e.g. by the manufacturing machine from FIG. 1 and/or FIG. 4) on the basis of the three-dimensional model and the manufacturing instructions. The measured values are captured in each case for the manufacturing reference values and/or the manufacturing tolerance values and/or the intervention tolerance values.

The method comprises a third method step 630 for checking the measured values, wherein the measured values are compared against the reference values. If a divergence of the measured values from the applicable manufacturing reference values and an exceeding of the associated manufacturing tolerance values and/or the associated intervention tolerance values are found, a control signal is provided or generated. A comparison is intended to be understood to mean in particular that the measured values are compared with the applicable manufacturing reference values and/or the applicable manufacturing tolerance values and/or the applicable intervention tolerance values and a check is performed to determine whether the measured values comply with the applicable manufacturing reference values and/or the applicable manufacturing tolerance values and/or the applicable intervention tolerance values. In particular, this comparison is performed for a measured value and the corresponding manufacturing reference values while taking into consideration the applicable manufacturing tolerance values and/or the applicable intervention tolerance values.

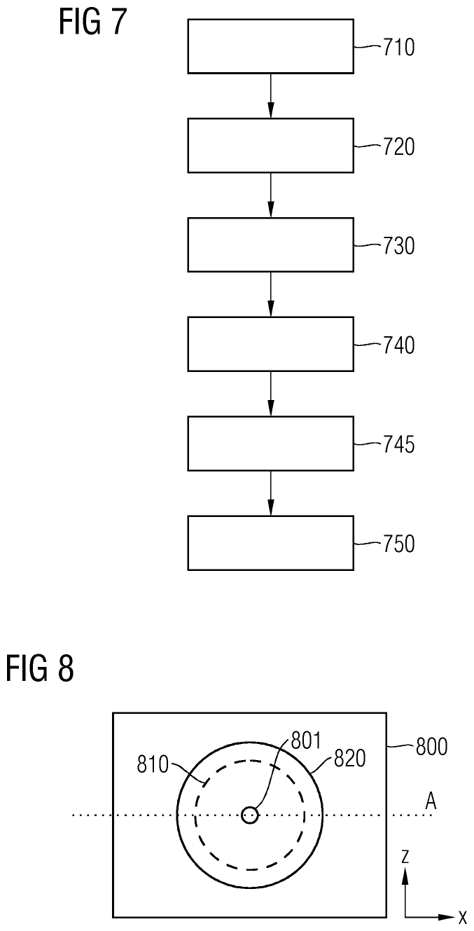

FIG. 7 shows a further exemplary embodiment of the teachings herein. Specifically, FIG. 7 shows a flowchart of an example method implemented as a computer-aided method. Specifically, a method for the computer-aided manufacture of an object by means of a manufacturing machine is depicted in this exemplary embodiment, wherein the manufacture (or the manufacturing process) of the object is monitored or checked.

The method comprises a first method step 710 for receiving a three-dimensional model and/or control commands, wherein the three-dimensional model comprises manufacturing instructions. The respective manufacturing instructions have manufacturing reference values and/or manufacturing tolerance values and/or intervention tolerance values assigned to them.

The method comprises a second method step 720 for calculating control commands by means of the three-dimensional model and the manufacturing instructions. Depending on the chosen implementation variant, the second method step is optional.

The method comprises a third method step 730 for manufacturing an object corresponding to the three-dimensional model, wherein the three-dimensional model, the manufacturing instructions and the control commands are used to configure the manufacturing machine such that the object is manufactured. Method steps one to three can be performed by a manufacturing machine, for example, as was explained in particular in FIGS. 1-4.

The method comprises a fourth method step 745 for capturing measured values, wherein the measured values are captured for the manufactured object by means of sensors. In this instance the object has been manufactured (e.g. by the manufacturing machine from FIG. 1 and/or FIG. 4) on the basis of the three-dimensional model and the manufacturing instructions. The measured values are captured in each case for the manufacturing reference values and/or the manufacturing tolerance values and/or the intervention tolerance values.

The method comprises a fifth method step 750 for checking the measured values, wherein the measured values are compared against the reference values. If a deviation of the measured values from the applicable manufacturing reference values and an exceeding of the associated manufacturing tolerance values and/or the associated intervention tolerance values are found, a control signal is provided or generated. The fourth and fifth method steps can be performed by a measuring device, for example, as shown in particular in FIGS. 1-4.

In this regard, the method can comprise an optional method step 740 for receiving a three-dimensional model, wherein the three-dimensional model comprises manufacturing instructions and the respective manufacturing instructions have the applicable manufacturing reference values and/or manufacturing tolerance values and/or intervention tolerance values assigned to them. This optional method step can likewise be performed by the measuring device.

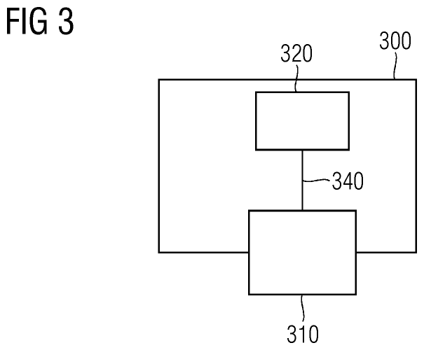

The transmission of the three-dimensional model to the measuring device can be effected for example by the manufacturing machine (e.g. the manufacturing machine 100 from FIG. 1 and/or FIG. 4) and/or by the apparatus 300 from FIGS. 3 and/or 4. This also applies in particular to the other exemplary embodiments shown.

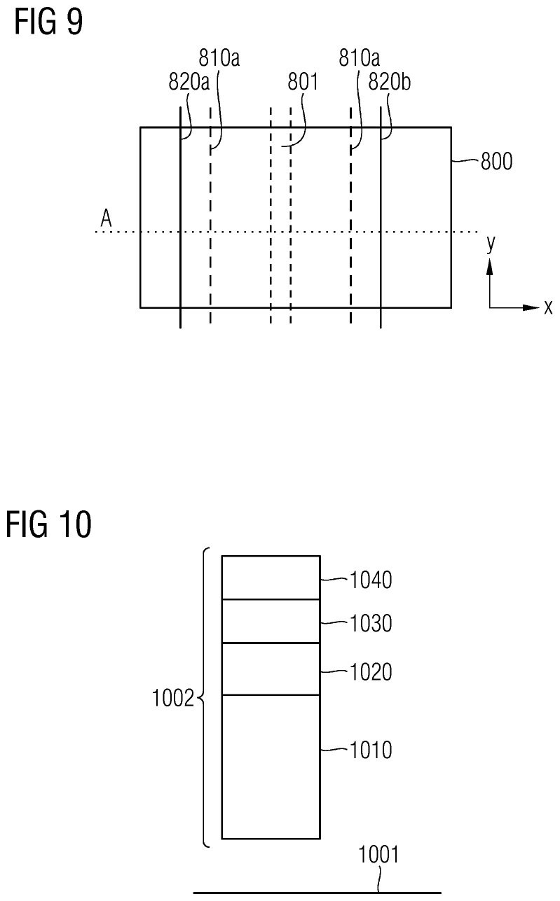

FIGS. 8 and 9 show a further exemplary embodiment of the teachings herein. Specifically, FIG. 8 and FIG. 9 depict a detail 800 from the three-dimensional model. The detail 800 shows a digital representation of a drill hole that is supposed to be drilled into an object/workpiece by means of a tool (e.g. a drill). The drill hole is stipulated by means of the manufacturing reference values 801 of the three-dimensional model. The detail shown may be a partial model of the three-dimensional model, for example.

FIG. 8 also shows the applicable intervention tolerance values 810 and the applicable manufacturing tolerance values 820. FIG. 8 shows the detail 800 in the XZ plane. If e.g. the detail 800 is cut along the sectional line A, a representation in the XY plane is obtained, which is depicted in FIG. 9, for example. In this case the relationship between these values can be defined as follows, for example:

|F(intervention tolerance values)|<|F(manufacturing tolerance values)|

where F is a function for determining the divergence of the measured values from the manufacturing reference values.

FIG. 9 shows the intervention tolerance values along the sectional line A from FIG. 8 in the XY plane. On the basis of the chosen depiction, the intervention tolerance values 810 are divided into left-hand intervention tolerance values 810a situated to the left of the manufacturing reference values and right-hand intervention tolerance values 810b situated to the right of the manufacturing reference values.

Analogously, the manufacturing tolerance values 820 are divided into left-hand manufacturing tolerance values 820a situated to the left of the manufacturing reference values and right-hand manufacturing tolerance values 820b situated to the right of the manufacturing reference values.

The three-dimensional model in this instance can be realized in different ways; for example it may be mapped out by points in three-dimensional space (e.g. by X, Y, Z coordinates). Alternatively, the three-dimensional model can be defined using polygons or voxels, wherein the three-dimensional model comprises or stores the necessary coordinates and/or functions for mapping out or defining the three-dimensional model. The three-dimensional model stipulates the (three-dimensional) geometric structure of the object to be manufactured by virtue of applicable (three-dimensional) (partial) structures to be manufactured of the three-dimensional model being produced (e.g. by means of surface machining operations, etc.) by one or more manufacturing machines for a workpiece or an object to be manufactured. The manufacturing reference values may be the applicable edges and/or surfaces of the three-dimensional model that are mapped out by the applicable points in three-dimensional space, by applicable polygons or by applicable voxels and the applicable coordinates (e.g. X, Y, Z coordinates). The applicable coordinates may stipulate or map out the manufacturing reference values, for example.

In other words, the three-dimensional model is a virtual representation of the object to be manufactured, wherein the three-dimensional model is used to stipulate the structures to be manufactured for the workpiece or the object to be manufactured. These structures to be manufactured for the workpiece or the object to be manufactured are then preferably produced by the manufacturing machines, and the production process is checked or monitored by means of the measuring device.

FIG. 10 shows an example of how manufacturing instructions 1002 may be assigned to a structure 1001 to be manufactured (that is to say in particular a digital/virtual three-dimensional representation of this structure by the three-dimensional model).

A first memory area 1010 can store first manufacturing instructions and/or first manufacturing reference values and/or first manufacturing tolerance values and/or first intervention tolerance values (so that a corresponding assignment is realized). These first values/manufacturing instructions are then relevant for example to a first processing step or machining process (e.g. sanding the surface of the workpiece) for a workpiece by a first manufacturing machine and are taken into consideration as appropriate e.g. when calculating control commands for the applicable manufacturing machine (e.g. only control commands for the applicable manufacturing machine are calculated and only these control commands relating to this manufacturing machine are transmitted to this manufacturing machine). Depending on the implementation variant, the first manufacturing instructions can also comprise or store the first manufacturing reference values and/or the first manufacturing tolerance values and/or the first intervention tolerance values.

Further processing steps or machining processes may be stipulated in each case in a second memory area 1020, in a third memory area 1030 and in a fourth memory area 1040. The sequence of the individual memory areas or manufacturing instructions that is thereby stipulated also allows a sequence to be stipulated for the manufacturing instructions that are to be performed, for example. As a result, in particular nonsensical sequences or sequences that destroy the workpiece can be prevented when the manufacturing instructions are performed. By way of example, painting a workpiece as a first machining process would be nonsensical if the workpiece is sanded down in a second machining process.

This arrangement of the memory areas can also be referred to as a vertical functional split of the manufacturing instructions, in particular as the positions or addresses of an applicable memory area can realize a concatenation over the addresses of a respective memory area. In this way, the manufacturing instructions with their memory areas can be realized as concatenated lists or concatenated blocks, for example.

The teachings herein, then, may be implemented as a system, an apparatus, a manufacturing machine, a measuring device, and/or methods for manufacturing a product. The disclosure allows a manufacturing installation to be automated to a greater extent by means of a three-dimensional data model, which moreover comprises manufacturing instructions, than has hitherto been possible with conventional automation networks. Although the teachings herein have been illustrated and described in more detail by the exemplary embodiments, the scope of the teachings is not limited by the disclosed examples, and other variations can be derived therefrom by a person skilled in the art without departing from the scope of the disclosure.

What is claimed is:

1. A manufacturing system comprising:
a first communication module for receiving a three-dimensional model and control commands, wherein
the three-dimensional model comprises manufacturing instructions for the manufacturing machine;
the manufacturing instructions have respective assigned manufacturing reference values and/or manufacturing tolerance values and/or intervention tolerance values;
a manufacturing module, wherein the three-dimensional model, the manufacturing instructions, and the control commands are used to configure the manufacturing module to manufacture an object corresponding to the three-dimensional model;
a calculating module using the three-dimensional model and the manufacturing instructions to calculate the control commands; and
a measuring device having
a second communication module for receiving the three-dimensional model,
a capture module
using sensors to capture measured values for the manufactured object, wherein
the measured values are captured in each case for the manufacturing reference values and/or the manufacturing tolerance values and/or intervention tolerance values, and
a checking module, wherein
a divergence of the measured values from the applicable manufacturing reference values and an exceeding of the associated manufacturing tolerance values and/or the associated intervention tolerance values result in a control signal.

2. The manufacturing system as claimed in claim 1, wherein:
the control signal is used to control rejection of the object to be manufactured in the event of one of the applicable manufacturing tolerance values being exceeded; or
the control signal is used to control refinishing of the object to be manufactured in the event of one of the applicable manufacturing tolerance values being exceeded; or
the control signal is used to control production of a replacement for the object to be manufactured in the event of one of the applicable manufacturing tolerance values being exceeded.

3. The manufacturing system as claimed in claim 1, wherein:
the control signal is used to control recalibration of the measuring device and/or of the manufacturing machine in the event of one of the applicable manufacturing tolerance values and/or of the applicable intervention tolerance values being exceeded; or
the control signal is used to control fresh capture and checking of the applicable measured values in the event of one of the applicable manufacturing tolerance values and/or of the applicable intervention tolerance values being exceeded; or
the control signal is used to control exchange of a tool in the event of one of the applicable manufacturing tolerance values and/or of the applicable intervention tolerance values being exceeded.

4. The manufacturing system as claimed in claim 1, wherein the manufacturing instructions are assigned to stipulated surfaces of the three-dimensional model.

5. The manufacturing system as claimed in claim 1, wherein
the control commands and/or the manufacturing instructions are used to select one or more tools
for the stipulated surfaces of the three-dimensional model.

6. The manufacturing system as claimed in claim 1, wherein
the control commands and/or the manufacturing instructions are used by the manufacturing machine to select one or more tools while taking into consideration a location of the manufacturing machine.

7. The manufacturing system as claimed in claim 1, wherein an appropriate tool is selected on the basis of the associated manufacturing reference values and/or the manufacturing tolerance values and/or the intervention tolerance values.

8. The manufacturing system as claimed in claim 1, wherein the three-dimensional model is transmitted from a providing apparatus to the manufacturing system and/or the manufacturing machine and/or the measuring device.

9. The manufacturing system as claimed in claim 1, wherein the manufacturing instructions comprise necessary prerequisites for subsequent manufacturing instructions.

10. The manufacturing system as claimed in claim 1, wherein the manufacturing instructions and the three-dimensional model stipulate structures to be manufactured for the object to be manufactured.

11. The manufacturing system as claimed in claim 1, wherein the selection of an appropriate tool is optimized on the basis of the associated manufacturing reference values and/or the manufacturing tolerance values and/or the intervention tolerance values.

12. An apparatus comprising:
a module for providing a three-dimensional model
including manufacturing instructions for a manufacturing machine;
wherein the three-dimensional model and the manufacturing instructions are used by the manufacturing machine to calculate control commands; and
the three-dimensional model, the manufacturing instructions, and the control commands are used to configure the manufacturing machine such that an object corresponding to the three-dimensional model is manufactured.

13. The apparatus as claimed in claim 12, wherein
the respective manufacturing instructions have manufacturing reference values and/or manufacturing tolerance values and/or intervention tolerance values assigned to them, wherein
the intervention tolerance values permit a smaller divergence from manufacturing reference values than the manufacturing tolerance values.

14. The apparatus as claimed in claim 12, wherein
measured values for the object to be manufactured are captured by a measuring device; and
the manufacturing reference values and/or the manufacturing tolerance values and/or intervention tolerance values are used to configure the measuring device such that a divergence of measured values from the applicable manufacturing tolerance values and an exceeding of the associated manufacturing tolerance values and/or the associated intervention tolerance values result in a control signal being provided.

15. The apparatus as claimed in claim 12, wherein the manufacturing instructions take into consideration necessary prerequisites for subsequent manufacturing instructions.

16. A manufacturing machine comprising:
a first communication module for receiving a three-dimensional model and/or control commands, wherein the three-dimensional model comprises manufacturing instructions for the manufacturing machine; and
a manufacturing module, wherein the three-dimensional model, the manufacturing instructions and the control commands are used to configure the manufacturing machine such that an object corresponding to the three-dimensional model is manufactured.

17. A measuring device comprising:
a communication module for receiving a three-dimensional model, wherein
the three-dimensional model comprises manufacturing instructions,
the respective manufacturing instructions have manufacturing reference values and/or manufacturing tolerance values and/or intervention tolerance values assigned to them;
a capture module
using sensors to capture measured values for a manufactured object;
wherein the object is manufactured on the basis of the three-dimensional model and the manufacturing instructions;
the measured values are captured in each case for the manufacturing reference values and/or the manufacturing tolerance values and/or intervention tolerance values; and
a checking module, wherein
a divergence of the measured values from the applicable manufacturing reference values and an exceeding of the associated manufacturing tolerance values and/or the associated intervention tolerance values result in a control signal.

18. A method for the computer-aided manufacture of an object by means of a manufacturing machine, the method comprising:
receiving a three-dimensional model and/or control commands, wherein the three-dimensional model comprises manufacturing instructions for the manufacturing machine; and
manufacturing an object corresponding to the three-dimensional model, wherein the three-dimensional model, the manufacturing instructions and the control commands are used to configure the manufacturing machine such that the object is manufactured.

19. A method for the computer-aided checking of an object manufactured by means of a manufacturing machine and/or of a manufacturing machine, having the following method steps:
receiving a three-dimensional model
comprising manufacturing instructions with
manufacturing reference values and/or manufacturing tolerance values and/or intervention tolerance values assigned to them;
capturing measured values
with one or more sensors;
wherein the object is manufactured on the basis of the three-dimensional model and the manufacturing instructions;
the measured values are captured in each case for the manufacturing reference values and/or the manufacturing tolerance values and/or the intervention tolerance values; and
checking the measured values
against the reference values;
wherein a divergence of the measured values from the applicable manufacturing reference values and an exceeding of the associated manufacturing tolerance values and/or the associated intervention tolerance values result in a control signal.

20. A method for the computer-aided manufacture of an object by means of a manufacturing machine, the method comprising:
receiving a three-dimensional model including
manufacturing instructions with assigned
manufacturing reference values and/or manufacturing tolerance values and/or intervention tolerance values;
manufacturing an object corresponding to the three-dimensional model;
wherein the three-dimensional model, the manufacturing instructions, and the control commands are used to configure the manufacturing machine such that the object is manufactured;
capturing measured values
using one or more sensors
for the manufacturing reference values and/or the manufacturing tolerance values and/or the intervention tolerance values; and
checking the measured values, wherein
a divergence of the measured values from the applicable manufacturing reference values and an exceeding of the associated manufacturing tolerance values and/or the associated intervention tolerance values result in a control signal.

21-23. (canceled)
